(19) United States
(12) Patent Application Publication
(10) Pub. No.: US 2022/0160121 A1
(43) Pub. Date: May 26, 2022

(54) DEVICE FOR CLEANING INTERDENTAL SPACES

(71) Applicants: Klaus Scholz, Erlangen (DE); Guenter Schwesig, Erlangen (DE); Andreas Zimmermann, Uttenreuth (DE)

(72) Inventors: Klaus Scholz, Erlangen (DE); Guenter Schwesig, Erlangen (DE); Andreas Zimmermann, Uttenreuth (DE)

(21) Appl. No.: 17/601,140

(22) PCT Filed: Apr. 2, 2020
(86) PCT No.: PCT/EP2020/059474

§ 371 Date: Oct. 4, 2021

(30) Foreign Application Priority Data
Apr. 3, 2019 (DE) 10 2019 002 448.6

(51) Int. Cl. A46B 13/02; H02K 7/00; H02K 7/075; A61C 15/04; A46B 5/00

(52) U.S. Cl. CPC A46B 13/026; H02K 7/003; A46B 2200/108; A61C 15/047; A46B 5/0016; H02K 7/075

(57) ABSTRACT

A device for cleaning interdental spaces includes a housing that forms a handle. The device also includes a brush holder for holding an interdental brush, and a drive device which is configured to generate rotational and translational movement of the brush holder and/or of an interdental brush held in the brush holder.

The invention relates to a device for cleaning interdental spaces.

Devices for cleaning interdental spaces are known most extensively as manually guided interdental space brushes—also referred to as interdental brushes. In addition, dental floss is also often used. A disadvantage with both variants is the relatively difficult handling. Dental floss is usually tensioned between two hands so that hardly any space for movement remains in the oral cavity. Interdental brushes are usually also small.

Electrically operated devices for cleaning interdental spaces are also known, however, which, for example, can be set in vibration or in a tilting motion.

The object of the invention is to improve the cleaning of interdental spaces.

This object is achieved in accordance with the invention by a device for cleaning interdental spaces having the features of claim 1. Advantages and embodiments and refinements which are partly inventive in their own right are presented in the dependent claims and the following description.

The device for cleaning interdental spaces according to the invention (referred to as an “interdental cleaner” for short) has a housing, which forms a handle, and a brush holder for holding an interdental space brush. Furthermore, the interdental cleaner has a drive device which is designed to generate a rotational and a translational movement of the brush holder and/or an interdental space brush (also: “interdental brush”) held therein.

Due to the rotational movement, a relatively high cleaning performance is achieved in the interdental spaces. This is additionally supported by the translational movement, i.e. a movement back and forth. In this case, the user only needs to hold the interdental cleaner in the position that is correct for himself. A manual movement of the interdental cleaner to and fro may even be omitted in this case.

In a preferred embodiment, the drive device is electromechanical.

Further preferably, the drive device comprises an electric motor.

In an expedient development, the housing has, in particular in the region of the handle, a receptacle for an energy store for the drive device. For example, the energy store is formed by one or more batteries, optionally accumulators. The energy store, in the event that it is rechargeable, is optionally designed to be charged without having to be removed from the housing. To this end, the interdental cleaner has a charging interface, for example a galvanic connection, or a charging coupling for contactless, in particular inductive charging. The energy store in this case optionally also has a charging electronics, which monitors the state of charge and/or the charging process.

In an expedient embodiment, the interdental cleaner has a control electronics, which is designed to perform a recurrent rotation reversal, in particular during a cleaning process (i.e. preferably during a period of time between activation and deactivation of the drive device).

In an optional embodiment, the drive device has a spindle drive for generating the translational movement. In particular, the threaded spindle of the spindle drive is coupled here to the motor shaft of the electric motor so as to be displaceable in the direction of the translational movement. In this case, the spindle nut is coupled non-displaceably to the housing. The threaded spindle is thus displaced in the longitudinal direction (which corresponds to the direction of the translational movement) as the electric motor rotates. In a simple variant, the interdental cleaner in this case has two end switches, which are coupled to the control electronics. The latter is preferably designed here to change the direction of rotation of the electric motor when one of the end switches is triggered.

In a variant, the drive device has a second electric motor, by means of which the transmission spindle is driven. The first electric motor is in this case used (furthermore) to generate the rotational movement. The advantage in this case lies in the fact that speed and extent of the translational movement can be selected independently of the rotational speed of the interdental brush.

In a further optional embodiment, the drive device has a solenoid, which is used to generate the translational movement and is preferably formed as an electromagnet. For example, the solenoid is rigidly coupled to the motor shaft and is designed to move the brush holder in translation (preferably relative to a return spring), in particular by activation and deactivation. Alternatively, the solenoid is rigidly secured to the housing, for example is tunnel-like or ring-like and is passed through by the motor shaft. The brush holder is displaceable in the longitudinal direction, but in the rotational direction if rigidly coupled to the solenoid or the motor shaft. Further alternatively, the solenoid is coupled to the brush holder and is consequently moved back and forth together with the brush holder upon activation and deactivation.

Again in an optional embodiment, the drive device has an eccentric transmission. This drives the brush holder for translational movement, for example, by means of a kind of connecting rod.

In a preferred embodiment, the drive device has a guide slot, which is used to generate the translational movement. A sliding block preferably slides in this guide slot. Either the guide slot or the sliding block is stationary relative to the housing, so that the translational movement is generated in the event that the guide slot runs at an incline to the longitudinal direction. The flatter the slotted guide is positioned here relative to a plane disposed perpendicularly to the motor shaft (or the longitudinal direction), the smaller is the “stroke” of the brush holder performed here as the motor rotates.

In a further expedient embodiment, the drive device has a driver sleeve. The brush holder is expediently coupled here to the driver sleeve by means of a magnetic coupling. The brush holder in this case has at least one magnet, which, when used correctly, is force-transmittingly coupled to a magnet, preferably with each pole coupled to an opposite pole of two magnets of the driver sleeve. The brush holder is thus moved at the same time together with the driver sleeve, both rotationally and translationally.

The magnetic coupling here allows a particularly expedient embodiment, in which the housing is closed fluid-tight between the driver sleeve and the brush holder. An infiltration of foreign substances into the housing is thus advantageously prevented. For example, the housing to this end forms a pot, in which the brush holder is enclosed from the outer side and around which the driver sleeve is arranged from the inner side.

In an expedient embodiment, the above-described guide slot is incorporated into the above-described driver sleeve (or into an (“other”) driver sleeve). Also for the case of a magnetic coupling other than the above-described magnetic coupling, the brush holder is coupled to the driver sleeve for the transfer of movement. The driver sleeve is preferably coupled here to the motor shaft so as to be displaceable translationally. The above-described sliding block is in this case preferably rigidly coupled to the housing.

The guide slot is designed to reduce the rotational speed, in particular by distributing a stroke over at least two revolutions of the driver sleeve. For example, the guide slot (in particular in a “developed” view) is incorporated as a sine curve into the lateral surface of the driver sleeve, wherein the sine curve crosses itself so that the overall amplitude is distributed over two revolutions.

In an advantageous embodiment, the brush holder is (preferably elongated and) elbowed. Interdental spaces that are relatively difficult to reach can thus also be reached. The brush holder in this case preferably also has a flexible shaft for transferring movement to the interdental brush.

In an expedient embodiment, the brush holder is designed to hold a double-sided interdental brush. For example, the interdental brush is for this purpose hinged so as to be pivotable through 180 degrees (and optionally so as to be displaceable slightly in the longitudinal direction for locking). The interdental brush in this case can have, for example, two brush heads with different diameters so that a user can clean interdental spaces of different sizes without changing between separate interdental brushes.

In an optional variant, the energy store can be swapped for a compressed air generator. In operation supplied with compressed air, this generator generates the energy that is otherwise provided by the energy store. The interdental cleaner can thus be used easily, for example, also in a dental practice. Alternatively, however, the drive device is designed purely mechanically for professional use, so that the brush holder, in particular the driver sleeve, is mechanically driven by means of a compressed air turbine. In other words, the above-described electric motor is omitted in this case.

The conjunction “and/or” shall be understood here and hereinafter in particular in such a way that the features linked by this conjunction can be formed both jointly and also as alternatives to one another.

Hereinafter, exemplary embodiments of the invention will be explained in greater detail on the basis of a drawing, in which:

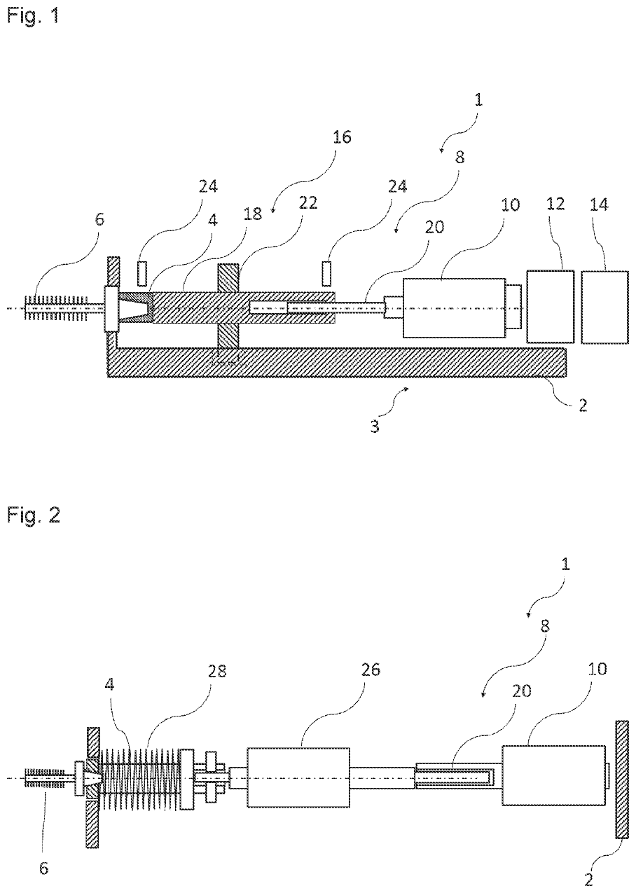

FIG. 1 shows a schematic, partially broken-open view of a device for cleaning interdental spaces,

FIG. 2 shows, in a view according to FIG. 1, an alternative exemplary embodiment of the device for cleaning interdental spaces,

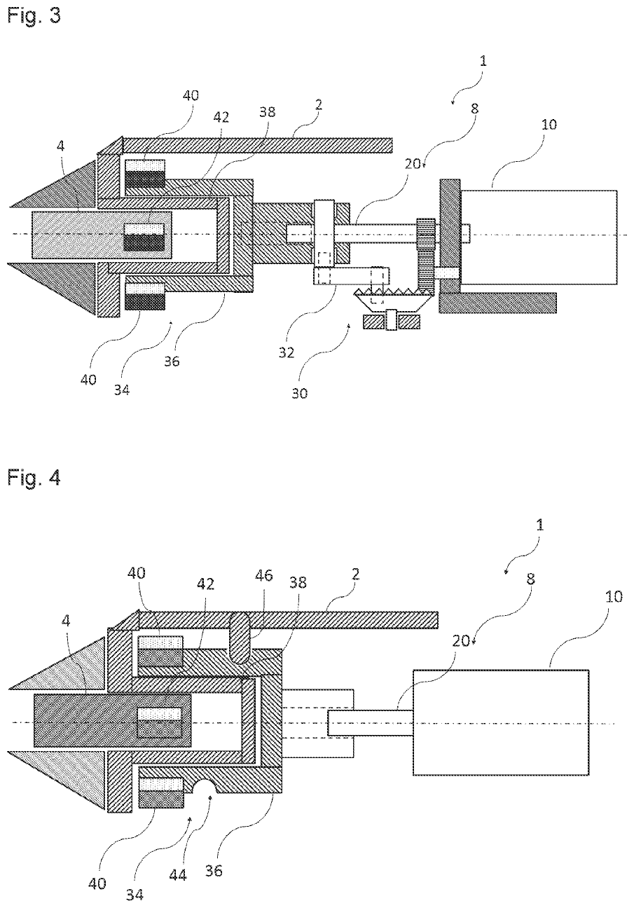

FIG. 3 shows, in a view according to FIG. 1, a further exemplary embodiment of the device for cleaning interdental spaces,

FIG. 4 shows, in a view according to FIG. 1, yet a further exemplary embodiment of the device for cleaning interdental spaces,

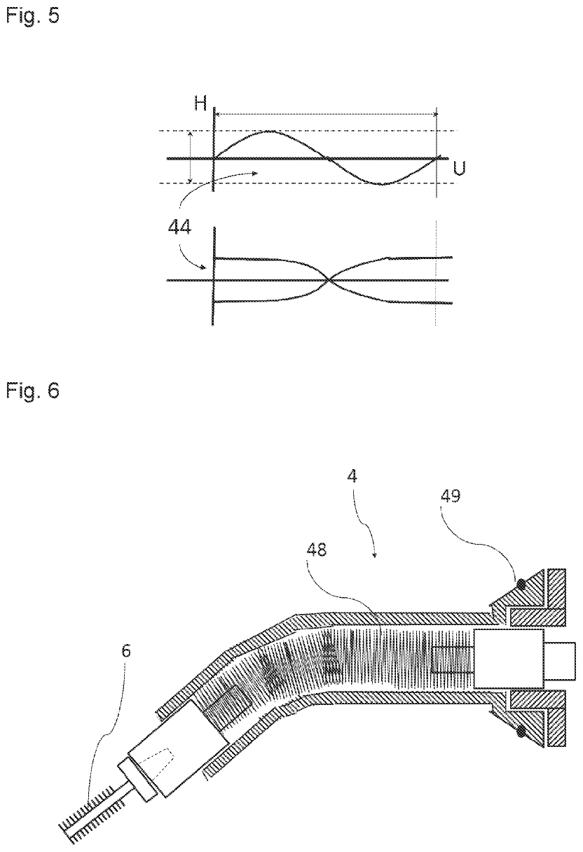

FIG. 5 shows, in a schematic developed view, three variants of a guide slot for translationally moving an interdental space brush of the device for cleaning interdental spaces,

FIG. 6 shows, in a view according to FIG. 1, an exemplary embodiment of a brush holder of the device for cleaning interdental spaces, and

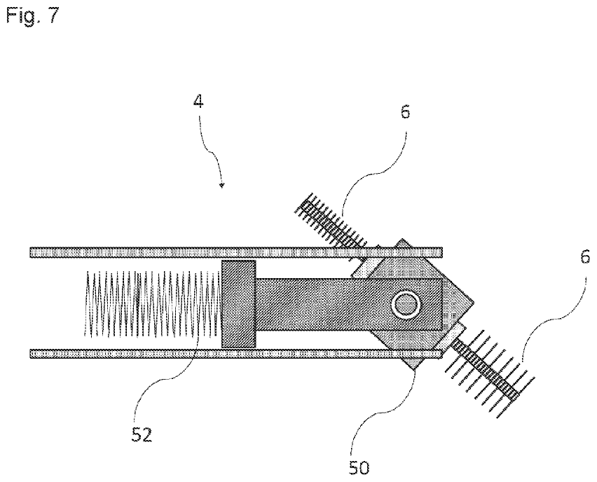

FIG. 7 shows, in a view according to FIG. 1, a further exemplary embodiment of the brush holder of the device for cleaning interdental spaces.

Parts that correspond to one another are always provided with the same reference signs in all figures.

A device for cleaning interdental spaces is schematically shown in FIG. 1 in a partially sectional and partially broken-open view of and will be referred to hereinafter as an “interdental cleaner 1”. This interdental cleaner 1 comprises a housing 2, which, with a portion thereof, forms a handle 3, by means of which the interdental cleaner 1 can be gripped and guided by a user. Furthermore, the interdental cleaner 1 comprises a brush holder 4, which, when operated as intended, holds an interdental space brush, or “interdental brush 6” for short. In addition, the interdental cleaner 1 comprises a drive device 8, which is designed to set the interdental brush 6 in rotation and to move it to and fro in the longitudinal direction—i.e. to effect a translational movement.

In the exemplary embodiment according to FIG. 1, the drive device 8 comprises an electric motor 10, a control electronics 12, and an energy store 14. The electric motor 10, when operated as intended, generates the rotation of the interdental brush 6. To generate the translation, the drive device 8 comprises a spindle drive 16. This in turn comprises a threaded spindle 18, which is coupled to the motor shaft 20 rotationally fixedly, but displaceably in the direction thereof. The latter is realized, for example, via a polygonal profile or a tongue-and-groove connection with play. The threaded spindle 18 is connected here rigidly to the brush holder 4. In addition, the spindle drive 16 comprises a spindle nut 22, which is held immovably in the housing 2. The threaded spindle 18 is thus displaced in rotation in its longitudinal direction.

The drive device 8 additionally comprises two end switches 24. As soon as these are triggered by the threaded spindle 18, the control electronics 12 initiates a rotation reversal of the electric motor 10, so that the threaded spindle 18 moves back again in the direction of the other end switch 24 and at the same time rotates the interdental brush 6 in the other direction.

The control electronics 12 is coupled to buttons, not shown in greater detail, by means of which the movement of the interdental brush can be activated and/or the movement speed can be varied.

FIG. 2 shows an alternative exemplary embodiment. For the translational movement, the drive device 8 comprises, instead of the spindle drive 16, an (electric) solenoid 26, which cooperates with a return spring 28 and, upon activation, moves the brush holder 4 with the interdental brush 6 relative to the return spring 28 in the longitudinal direction to the interdental brush 6.

FIG. 3 shows a further exemplary embodiment. For the translational movement, the drive device 8 comprises an eccentric transmission 30. A rotational movement is transferred in this transmission by means of a connecting rod 32 into the translational movement to and fro.

Furthermore, the interdental cleaner 1 comprises a magnetic coupling 34 between the motor shaft 20 and the brush holder 4. Here, a driver sleeve 36 is connected to the motor shaft 20 for conjoint rotation. The driver sleeve 36 surrounds a closed housing pot 38, likewise in a pot-like manner and carries two driver magnets 40. The brush holder 4 sits in the housing pot 38 and in this embodiment carries a coupling magnet 42. This coupling magnet 42 couples to the (oppositely poled) driver magnets 40. Both a transfer of rotation and a transfer of the translation of the driver sleeve 36 thus occur.

FIG. 4 shows an exemplary embodiment that has been varied in relation to the exemplary embodiment according to FIG. 3. The eccentric transmission 30 is not provided in this case. For the translation of the brush holder 4, a guide slot 44 is incorporated into the driver sleeve 36 and a sliding block 46 engages in said guide slot. The sliding block is immovably connected to the housing 2. The guide slot 44 here describes a curve that is positioned at an incline to the axis of the motor shaft 20.

FIG. 5 shows, by way of example, two different profiles of the curve described by the guide slot 44, in a developed view over a revolution U of the driver sleeve 36. The uppermost curve forms a sine curve, in which case a complete stroke H of the brush holder 4 is performed per revolution U of the driver sleeve 36.

The lower curve represents a reduction, wherein the guide slot 44 (in a developed view) reproduces a horizontal eight and thus crosses itself once. Consequently, only a half stroke H is thus performed with one revolution U.

FIG. 6 shows a variant of the brush holder 4. The brush holder 4 is elbowed here and has a flexible shaft 48. The rotation and the translation can thus be transferred to the interdental brush 6 over the elbow.

The brush holder 4 in this case optionally also has a coding ring 49, so as to be able to assign a brush holder 4 user-specifically in each case, for example by means of color coding.

FIG. 7 shows a further variant of the brush holder 4. The brush holder 4 is designed here to hold a double brush, i.e. two different interdental brushes 6, on a support 50. The two interdental brushes 6 are secured here to the support 50 in a manner directed 180 degrees away from one another and can be rotated in the brush holder 4. For example, the support 50 is mounted in a slot, tensioned against a spring 52 and can be displaced against the spring force into a region of the brush holder 4 in which a pivoting of the support 50 is released.

The subject matter of the invention is not limited to the above-described exemplary embodiments. Rather, further embodiments of the invention can be deduced by a person skilled in the art from the above description. In particular, the individual features of the invention described on the basis of the various exemplary embodiments and the design variants of these features can also be combined with one another in a different way.

### LIST OF REFERENCE SIGNS

1 interdental cleaner
2 housing
3 handle
4 brush holder
6 interdental brush
8 drive device
10 electric motor
12 control electronics
14 energy store
16 spindle drive
18 threaded spindle
20 motor shaft
22 spindle nut
24 end switch
26 solenoid
28 return spring
30 eccentric transmission
32 connecting rod
34 magnetic coupling
36 driver sleeve
38 housing pot
40 driver magnet
42 coupling magnet
44 guide slot
46 sliding block
48 shaft
49 coding ring
50 support
52 spring
H stroke
U revolution

1-13. (canceled)

14. A device for cleaning interdental spaces, the device comprising:
a housing forming a handle;
a brush holder associated with said housing for holding an interdental space brush; and
a drive device configured to generate a rotational and a translational movement of at least one of said brush holder or an interdental space brush held in said brush holder;
said drive device having an eccentric transmission driving said brush holder for translational movement.

15. The device for cleaning interdental spaces according to claim 14, which further comprises a connecting rod connected between said eccentric transmission and at least one of said brush holder or the interdental space brush.

16. The device for cleaning interdental spaces according to claim 14, wherein said drive device has a driver sleeve, and a magnetic coupling couples said brush holder to said driver sleeve.

17. The device for cleaning interdental spaces according to claim 16, wherein said housing is fluid-tightly closed between said driver sleeve and said brush holder.

18. The device for cleaning interdental spaces according to claim 14, wherein said drive device is electromechanical.

19. The device for cleaning interdental spaces according to claim 17, wherein said drive device includes an electric motor.

20. The device for cleaning interdental spaces according to claim 16, wherein said drive device includes an electric motor having a motor shaft connected to said driver sleeve.

21. The device for cleaning interdental spaces according to claim 16, which further comprises:
a closed housing pot surrounded by said driver sleeve in a pot-shaped manner;
two driver magnets carried by said driver sleeve;
said brush holder sitting in said housing pot; and
a coupling magnet carried by said brush holder for coupling to said two driver magnets to transfer the rotation and the translation from said driver sleeve to said brush holder.

22. The device for cleaning interdental spaces according to claim 14, wherein said brush holder is elbowed and has a flexible shaft for transferring movement to the interdental space brush.

23. The device for cleaning interdental spaces according to claim 14, which further comprises control electronics configured to perform a recurrent rotation reversal of said brush holder.

24. The device for cleaning interdental spaces according to claim 14, wherein said brush holder is configured for holding a double-sided interdental space brush.
